(19) United States
(12) Patent Application Publication
(10) Pub. No.: US 2024/0212081 A1
(43) Pub. Date: Jun. 27, 2024

(54) SYSTEM AND METHOD FOR PROVIDING A CONTEXT-BASED USER TRUST SCORE

(71) Applicant: NCR Corporation, Atlanta, GA (US)

(72) Inventor: Bryan Walser Nonni, Atlanta, GA (US)

(21) Appl. No.: 18/085,715

(22) Filed: Dec. 21, 2022

(51) Int. Cl. G06Q 50/26; G06F 9/54; H04L 67/02

(52) U.S. Cl. CPC G06Q 50/26; G06F 9/547; H04L 67/02

(57) ABSTRACT

A system and method for generating a context-based user trust score is disclosed. A user requests, via a user application running on a personal device, access to a premium service. The premium service is related to a particular market segment. The user then grants, via the user application running on the personal device, access to a subset of personally identifiable information stored on a decentralized web node of a user. The subset of personally identifiable information is related to the particular market segment. A trust score application programming interface running on a processor accesses the subset of personally identifiable information on the decentralized web node of the user and calculates a context-based user trust score based thereon. The trust score application programming interface running on the processor then provides the calculated context-based user trust score, which is preferably a verifiable credential, to the decentralized web node of the user.

### FIELD

This disclosure relates generally to a system and method for providing a context-based user trust score and more particularly to a system and method for creating a user trust score based on information stored in a self-sovereign identity storage location of a user.

### BACKGROUND

Enterprises and governments rely heavily on collecting data from their customers and citizens. In fact, private and public information about every individual is almost certainly maintained by a plethora of different entities in a variety of data warehouse located across the globe. This has caused a great deal of problems for individuals and for the enterprises. The personal data and private data of individuals are routinely stolen and used for nefarious purposes with the unwittingly assistance of government bureaucrats and government systems to obtain false government identification cards or government benefits. Consumers are frequently targeted and harassed by businesses based on their spending habits, browser history, and location data.

In the midst of this chaos, governments are finally realizing that data about an individual should belong to the individual and not collected and used by businesses, governments, or organizations. Some countries have adopted more stringent laws and regulations should a consumer be harmed by a data breach at an enterprise that houses some of the consumer's data. Some countries have adopted laws that make clear any retention of consumer data needs to have the express informed consent of the consumer and/or requires payment of a fee to the consumer.

The World Wide Web (Web) is an information system that allows documents and other resources to be accessed over the internet. Under the original Web model, users do not control their own data or identity. Instead, providers of services (for example) over the internet give each user an account (username/password) and all information and data associated with that account is stored by the provider. A new Web model (Web 5) has been proposed which moves the control of user information and data back to the user by decentralizing how information is stored. Under this model, users obtain decentralized identifiers (DIDs) for identification purposes which are not controlled by any provider. In addition, Web 5 provides for verifiable credentials (VCs) that enable trustless interactions. The VCs are cryptographically signed by the issuer and include information from that issuer about the user (e.g., a financial institution can issue a VC which identifies a user's bank account and other desired information related thereto). Web 5 further provides for decentralized web nodes (DWNs). A DWN is a data storage and message relay mechanism entities can use to locate public or private permissioned data related to a given DID. Although blockchain is not a necessary part of Web 5, blockchains offer may advantages for storing DIDs and offer advantages in further improving the level of trust, transparency and the overall efficiencies required for a decentralized system like Web 5. A user's DWN can serve as a self-sovereign identify storage location (wallet).

There is currently no good way to provide consumers with premium services in various market segments (retail businesses, hospitality such as restaurants, banking or related financial institutions) based on some verifiable level of trust in the consumer's good behavior without invading consumer privacy and/or housing sensitive personal identifiable information of the consumer.

Accordingly, because of the drawbacks recited above, there is a need for a system and method for creating a user trust score based on information stored in a self-sovereign identity storage location of a user, the user trust score for use as a verifiable credential for trustless interactions.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system for use in generating a self-sovereign identity-based user trust score according to the present disclosure;

FIG. 2 is a block diagram of a server system for hosting an application program interface according to the present disclosure; and

FIG. 3 is a flowchart of a method for use in generating a self-sovereign identity-based user trust score according to the present disclosure.

### DETAILED DESCRIPTION

In the present disclosure, like reference numbers refer to like elements throughout the drawings, which illustrate various exemplary embodiments of the present disclosure.

The present disclosure describes a system and method for creating a credit profile housed in a self-sovereign identity storage location for a user and an associated user trust score based on the credit profile that can be used as a verifiable credential for trustless interactions. The trust score can be used to provide premium services to consumers in various industries based on that consumer's actual behavior profile without any of the consumer's personal identifiable information being stored in a permanent manner by the service provider. There are many examples of premium services that may be provided to consumes, including self-checkout at non-traditional retail stores, enhanced forms of self-checkout or access to special products at a retail store, ordering or reservations without pre-payment at a restaurant, priority seating at a restaurant or airline, access to enhanced borrowing/lending services at financial institution, decentralized buying, selling, and/or lending at a financial institution, etc.

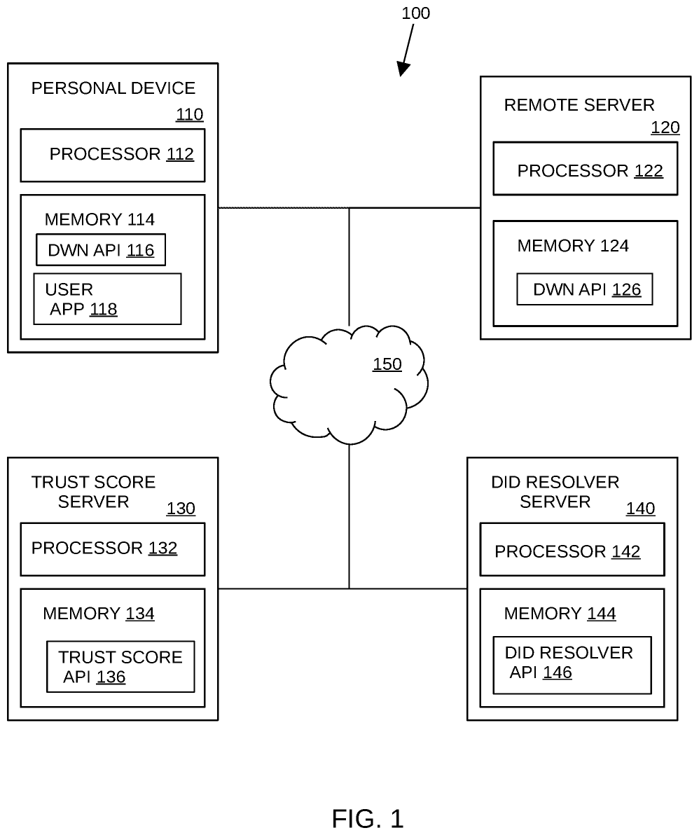

Referring now to FIG. 1, the system 100 includes a personal device 110, a remote server 120 for generating a remote decentralized web node, a trust score server 130 for generating a trust score as discussed below, and a DID resolver server 140, which all are linked via an internet connection 150.

The personal device 110 (a user device) may be a mobile device or other type of computing device (e.g., a personal computer). The personal device 110 includes a processor 112 and a memory 114. The memory 114 is a non-transitory computer-readable storage medium such as hard disk drive used to hold application programs, an operating system, and user data. A decentralized web node (DWN) application programming interface (API) 116 and a user application (app) 118 are stored in the memory 114. The DWN API 116 operates to provide a local DWN that has a secure storage area for user data, accessible via DID-relative addressing. The user's DWN acts as a self-sovereign identity wallet, securely storing user information that can be accessed only when the user provides access thereto., The user app 118 provides a user interface and functionality to manage credentials and app data stored in the DWN. The user app 118 also provides credential functions, DID functions, DID authentication, and context management. The user app 118 also provides the user with the ability to request a trust score for a particular context, as discussed below and to grant access to a subset of data stored in the DWN necessary for determining the contextual trust score.

The remote server 120 includes a processor 122 and a memory 124. The memory 124 is a non-transitory computer-readable storage medium such as hard disk drive used to hold application programs, an operating system, and user data. The DWN API 126 provides a remote DWN that has a secure storage area for user data, accessible via DID-relative addressing, under the control of the user app 118 running on the personal device 110 of the associated user. In some cases, the remote DWN may not be necessary and only a local DWN is provided.

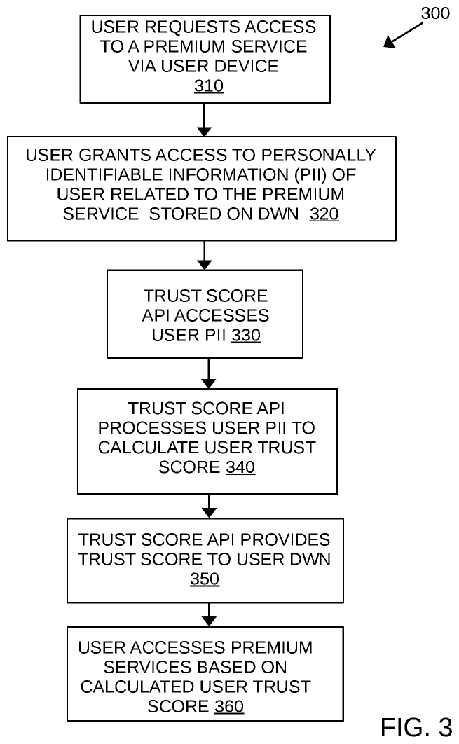

The trust score server 130 includes a processor 132 and a memory 134. The memory 134 is a non-transitory computer-readable storage medium such as hard disk drive used to hold application programs, an operating system, and user data. A trust score API 136 is stored in memory 134. The trust score API 136 operates as shown in the flowchart 300 in FIG. 3 and discussed below.

The DID resolver server 140 includes a processor 142 and a memory 144. The memory 144 is a non-transitory computer-readable storage medium such as hard disk drive used to hold application programs, an operating system, and user data. A DID resolver API 146 is stored in memory 144. Under Web 5, the decentralized identifiers (or DIDs) are self-generated and self-owned. The DID resolver functions provided by the DID resolver API 146 are used to locate DID documents associated with DIDs in an associated distributed ledger (e.g., a blockchain). The DID resolver server 140 operates according to the Web 5 model.

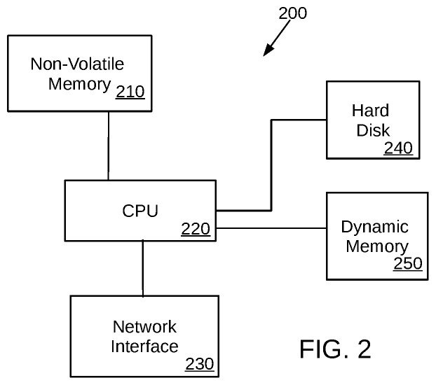

Each server and device discussed with respect to FIG. 1 may correspond to or include a similar topology as server 200 shown in FIG. 2. Server 200 is preferably a hardware-based computing system which includes one or more central processing units 220, a network interface 230, at least one hard disk (HD) 240, volatile memory 250, and non-volatile memory 210. The non-volatile memory 210 may include a basic input/output system (BIOS) used to initiate a boot of the server 200. The HD 240 may be any type of non-volatile memory device (i.e., a non-transitory computer-readable storage medium) used to hold an operating system for a computer-based system (and application programs including APIs) and the term “hard disk” as used herein is intended to be broadly defined to include both electro-mechanical data storage devices and solid-state drives. The HD 240 holds the programs (software applications) which load into volatile memory 250 upon boot of the operating system to provide the functionality of such programs, including the one or more of the APIs discussed herein. It is to be noted that the components are shown schematically in greatly simplified form, with only those components relevant to understanding of the embodiments being illustrated. The various components (that are identified in the FIG. 2) are illustrated and the arrangement of the components is presented for purposes of illustration only. It is to be noted that other arrangements with more or less components are possible without departing from the teachings of the system and method presented herein. In one presently preferred embodiment, server 200 comprises a computing system adapted to run a secure version of the Microsoft Windows® operating system or a secure Linux distribution.

Referring now to the flowchart 300 of FIG. 3, in operation, a user may elect to participate in a premium services offer at step 310. The user may respond to an offer provided via an email, a text message, a website, or provider app. The premium services offer is limited to a particular market segment and may be a benefit not provided to all customers such as enhanced checkout procedures at a retail establishment, priority seating at a restaurant, more favorable lending rates at a bank, etc. The system and method of the present disclosure is adaptable for many different types of market segments, including but not limited to retail business, hospitality businesses such as bars and restaurants, banking or related financial institutions, hotels, transportation, etc. The user next grants access to personally identifiable information of the user stored in the user's decentralized web node (either the local or remote version) at step 320. Typically, this grant will be limited to only that part of the personally identifiable information that is relevant to the premium services requested, e.g., information about frequency of visits to a particular retail establishment or restaurant, along with amounts spent there. The trust score API next accesses the user's personally identifiable information at step 330 and processes the accessed information to calculate a trust score at step 340. The user's personally identifiable information is preferably received in encrypted form at the trust score API and is erased once the trust score is calculated. In an alternative embodiment, the user's personally identifiable information is analyzed via homomorphic encryption in order to better safeguard that information. The value of the trust score will depend on the context, for retail establishments and restaurants, the trust score will be proportional to the number of visits and amount spent per visit. For banking, the trust score may be calculated based on income, assets. and payment history in a manner similar to a credit score. The trust score can even be used to access bars and nightclubs, by generating a trust score that simply provides an indication of whether the user is a certain age or older. Once the trust score is calculated, it is provided to the user at step 350 for storage in the user's decentralized web node. The trust score is preferably formatted as a verifiable credential of the user. Thereafter, the user is able to access to the desired premium services related to the trust score by granting access to the trust score to the provided of such services, step 360.

Web 5 provides a new identity layer for the Web to enable decentralized apps and protocols that is intended to empower individuals with self-owned identity and control over their personally identifiable information. The trust score of the present disclosure is a data profile that is based on some or all the following data about the user: state-issued identity docs, in-store/online purchase history, bill pay history, address, phone, email, debt payment history, mortgage activity, credit card activity, loan activity, income, pay stubs, etc. The trust score can be based on any information that can be leveraged to properly assess a consumer's worthiness for trust in a particular context. For example, social media content history could be analyzed and leveraged for use in granting access to premium services in the hospitality area. As explained above, a consumer desiring access to premium products or services may opt into the trust score system and allow access to their personal data. The system analyzes this data (in some cases using homomorphic encryption) to generate the trust score credential about the consumer while throwing out the data (or not getting unencrypted access to it). The trust score credential is contextual in nature and will be different depending on the types of products or services desired by the consumer (banking services, retail products, hospitality services, etc.). The trust score credential may then be used by services providers or retailers to provide consumers with different levels of access to different services in an opt-in fashion (i.e., age-verified purchases online, buy/sell cryptocurrency, acquire loans, buying, selling or borrowing via a decentralized exchange, vision checkout, just-walk-out checkout, etc.) based on their trust score credential.

The system and method of the present disclosure provides an entirely new system of managing identify information based on Web 5 constructs including Decentralized Web Nodes (DWNs) and Self-Sovereign Identity (SSI) Verifiable Credentials (VCs). By providing a system in which providers are given an additional level of trust in consumers, providers will offer better products/services and consumers will have access to premium products/services based only on sharing their data for generating the trust score. Consumers using the system and method of the present disclosure will be assured that no copies of their personal identifiable information will exist anywhere in random servers throughout the internet based on the use of this system.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method of generating a context-based user trust score, comprising:
requesting, via a user application running on a personal device, access to a premium service, the premium service related to a particular market segment;
granting, via the user application running on the personal device, access to a subset of personally identifiable information stored on a decentralized web node of a user, the subset of personally identifiable information related to the particular market segment;
accessing, by a trust score application programming interface running on a processor, the subset of personally identifiable information on the decentralized web node of the user and calculating a context-based user trust score based thereon; and
providing, by the trust score application programming interface running on the processor, the calculated context-based user trust score to the decentralized web node of the user.

2. The method of claim 1, wherein the decentralized web node of a user is provided locally via the personal device.

3. The method of claim 1, wherein the decentralized web node of a user is provided remotely via a decentralized web node application programming interface running on a processor at a remote server.

4. The method of claim 1, wherein the particular market segment corresponds to retail businesses.

5. The method of claim 1, wherein the particular market segment corresponds to hospitality businesses.

6. The method of claim 1, wherein the particular market segment corresponds to financial institutions.

7. The method of claim 1, wherein the decentralized web node is identified by a decentralized identifier.

8. The method of claim 7, wherein the decentralized identifier is obtained via a decentralized identifier resolver application programming interface running on an associated processor of a decentralized identifier resolver server.

9. The method of claim 1, wherein the context-based user trust score is a verifiable credential.

10. The method of claim 1, wherein the subset of personally identifiable information accessed by the trust score application programming interface is processed using homomorphic encryption.

11. A system of generating a context-based user trust score, comprising:
a user device having a processor and a non-transitory computer-readable storage medium, the non-transitory computer-readable storage medium having executable instructions for a user application, which when executed, cause the processor to perform the following operations:
request access to a premium service, the premium service related to a particular market segment; and
grant access to a subset of personally identifiable information stored on a decentralized web node of a user, the subset of personally identifiable information related to the particular market segment; and
a trust score server having a processor and a non-transitory computer-readable storage medium, the non-transitory computer-readable storage medium having executable instructions for a trust score application programming interface, which when executed, cause the processor to perform the following operations:
access the subset of personally identifiable information on the decentralized web node of the user and calculating a context-based user trust score based thereon; and
provide the calculated context-based user trust score to the decentralized web node of the user.

12. The system of claim 11, wherein the decentralized web node of a user is provided locally via the user device.

13. The system of claim 11, wherein the decentralized web node of a user is provided remotely via a decentralized web node application programming interface running on a processor at a remote server.

14. The system of claim 11, wherein the particular market segment corresponds to retail businesses.

15. The system of claim 11, wherein the particular market segment corresponds to hospitality businesses.

16. The system of claim 11, wherein the particular market segment corresponds to financial institutions.

17. The system of claim 11, wherein the decentralized web node is identified by a decentralized identifier.

18. The system of claim 17, further comprising a decentralized identifier resolver server having a processor and a non-transitory computer-readable storage medium, the non-transitory computer-readable storage medium having executable instructions for a decentralized identifier resolver application programming interface, which when executed, cause the processor to perform the following operations:
provide the decentralized identifier upon request from an associated distributed ledger.

19. The system of claim 11, wherein the context-based user trust score is a verifiable credential.

20. The system of claim 11, wherein the subset of personally identifiable information accessed by the trust score application programming interface is processed using homomorphic encryption.
